(19) United States
(12) Patent Application Publication
(10) Pub. No.: US 2025/0181938 A1
(43) Pub. Date: Jun. 5, 2025

(54) INFORMATION PROCESSING DEVICE, INFERENCE SYSTEM, AND CONTROL METHOD

(71) Applicant: Mitsubishi Electric Corporation, Chiyoda-ku, Tokyo (JP)

(72) Inventors: Hidemichi SUZUKI, Tokyo (JP); Makoto YAMASHITA, Tokyo (JP); Masahide KOIKE, Tokyo (JP)

(21) Appl. No.: 18/845,294

(22) PCT Filed: Apr. 26, 2022
(86) PCT No.: PCT/JP2022/018866

§ 371 Date: Sep. 9, 2024

(51) Int. Cl. G06N 5/04

(52) U.S. Cl. CPC G06N 5/04

(57) ABSTRACT

An information processing device includes inference processing devices differing from each other in performance or a configuration, an acquisition unit that acquires a learned model, inference data as data to be used in an inference process, and an inference control program for having a data format of the inference data converted to a data format appropriate for a first inference processing device to be made to execute the inference process out of the inference processing devices and making the first inference processing device execute the inference process, a data format conversion unit that converts the data format of the inference data, and an inference control unit that makes the first inference processing device execute the inference process by use of converted inference data after the data format conversion and the learned model.

### TECHNICAL FIELD

The present disclosure relates to an information processing device, an inference system and a control method.

### BACKGROUND ART

In recent years, performance of Central Processing Units (CPUs), Graphics Processing Units (GPUs) and the like is increasing. The CPUs, GPUs and the like are used for a process of detecting a suspicious object or a suspicious person, real-time translation, autonomous driving, and so forth.

Further, there have been proposed a plurality of devices respectively including an analysis unit that executes a process of analyzing equivalent contents (see Patent Reference 1).

### PRIOR ART REFERENCE

### Patent Reference

Patent Reference 1: WO 2013/145530

### SUMMARY OF THE INVENTION

### Problem to be Solved by the Invention

Incidentally, there are cases where a plurality of inference processing devices exist. Each inference processing device is capable of making inference by using data. When the plurality of inference processing devices have the same performance and configuration, it is unnecessary to convert the data format of the data. However, when the plurality of inference processing devices differ from each other in the performance or the configuration, it is necessary to convert the data to a data format appropriate for each inference processing device. Thus, when the plurality of inference processing devices differ from each other in the performance or the configuration, a user converts the data to a data format appropriate for each inference processing device. However, the conversion work performed by the user increases the load on the user.

An object of the present disclosure is to reduce the load.

### Means for Solving the Problem

An information processing device according to an aspect of the present disclosure is provided. The information processing device includes a plurality of inference processing devices differing from each other in performance or a configuration, an acquisition unit that acquires a learned model, inference data as data to be used in an inference process, and an inference control program for having a data format of the inference data converted to a data format appropriate for a first inference processing device to be made to execute the inference process out of the plurality of inference processing devices and making process, a data format conversion unit that converts the data format of the inference data, and an inference control unit that makes the first inference processing device execute the inference process by use of converted inference data after the data format conversion and the learned model.

### Effect of the Invention

According to the present disclosure, the load can be reduced.

### BRIEF DESCRIPTION OF THE DRAWINGS

FIG. 1 is a diagram showing an inference processing system in a first embodiment.

FIG. 2 is a diagram (No. 1) showing an example of actual use of the inference processing system in the first embodiment.

FIG. 3 is a diagram (No. 2) showing an example of actual use of the inference processing system in the first embodiment.

FIG. 4 is a diagram (No. 3) showing an example of actual use of the inference processing system in the first embodiment.

FIG. 5 is a diagram showing a case where an information processing device in the first embodiment includes the inference processing system.

FIG. 6 is a block diagram showing functions of the information processing device in the first embodiment.

FIG. 7 is a block diagram showing functions of a schedule control unit in the first embodiment.

FIG. 8 is a flowchart (part 1) showing an example of a process executed by the information processing device in the first embodiment.

FIG. 9 is a flowchart (part 2) showing the example of the process executed by the information processing device in the first embodiment.

FIG. 10 is a diagram showing examples of a situation where the load becomes high in a second embodiment.

FIG. 11 is a block diagram showing functions of an information processing device in the second embodiment.

FIG. 12 is a flowchart (part 1) showing an example of a process executed by the information processing device in the second embodiment.

FIG. 13 is a flowchart (part 2) showing the example of the process executed by the information processing device in the second embodiment.

FIG. 14 is a diagram showing an example of a situation where control in the second embodiment has been executed.

### MODE FOR CARRYING OUT THE INVENTION

Embodiments will be described below with reference to the drawings. The following embodiments are just examples and a variety of modifications are possible within the scope of the present disclosure.

### First Embodiment

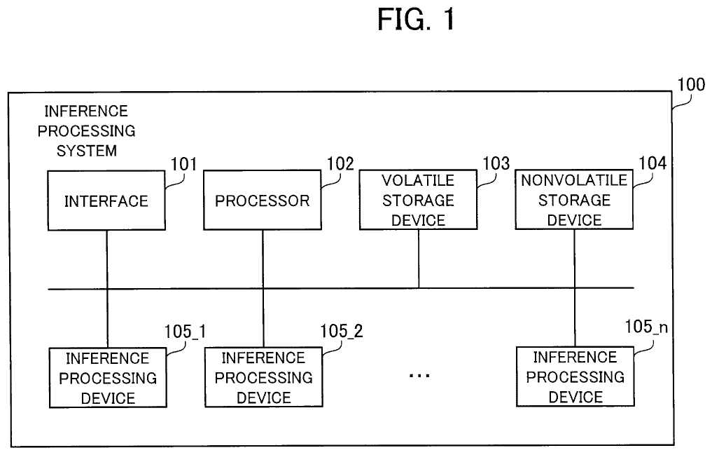

FIG. 1 is a diagram showing an inference processing system in a first embodiment. The inference processing system 100 includes an interface 101, a processor 102, a volatile storage device 103, a nonvolatile storage device 104, and inference processing devices 105_1, 105_2, . . . , 105_n (n: positive integer). Further, the inference processing system 100 may include processing circuitry.

The interface 101 transmits a variety of information to the processor 102. Further, when the inference processing system 100 connects to an external device, the interface 101 executes communication with the external device. The processor 102 is a CPU, for example. The processor 102 can also be a multiprocessor. The volatile storage device 103 is a Random Access Memory (RAM), for example. The nonvolatile storage device 104 is a Hard Disk Drive (HDD) or a Solid State Drive (SSD), for example.

The inference processing devices 105_1, . . . , 105_n differ from each other in the performance or the configuration. The inference processing devices 105_1, . . . , 105_n may also be represented as devices differing from each other in the performance or differing from each other in the type. For example, each of the inference processing devices 105_1, . . . , 105_n can be a GPU, a Field Programmable Gate Array (FPGA), a Digital Signal Processor (DSP), a Dynamically Reconfigurable Processor (DRP), or the like.

Next, examples of actual use of the inference processing system 100 will be shown below.

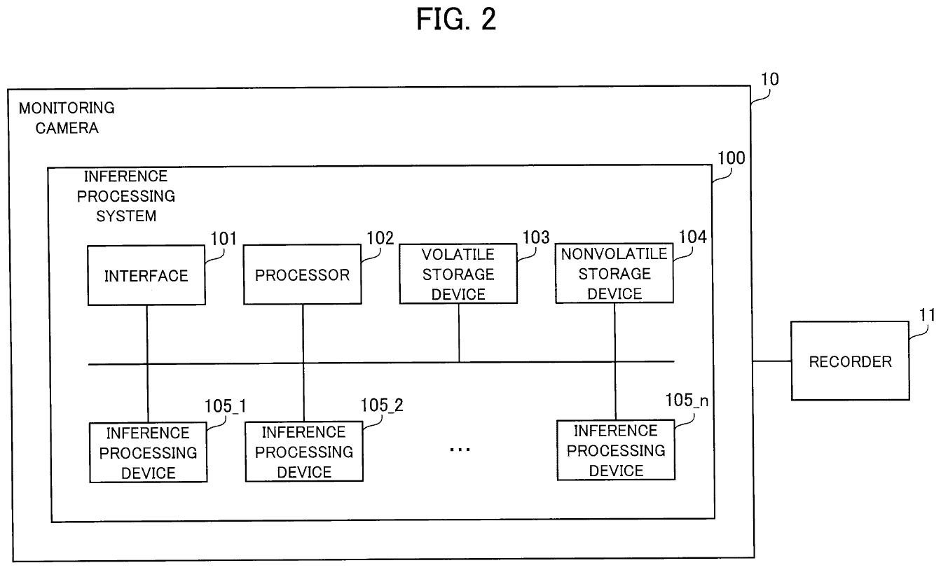

FIG. 2 is a diagram (No. 1) showing an example of actual use of the inference processing system in the first embodiment. FIG. 2 shows a case where a monitoring camera 10 includes the inference processing system 100. Further, a recorder 11 is connected to the monitoring camera 10. A Personal Computer (PC) may be connected to the monitoring camera 10 instead of the recorder 11. For example, the inference processing system 100 makes person inference by using an image (i.e., inference data) generated by the monitoring camera 10. The monitoring camera 10 transmits the image and an inference result to the recorder 11.

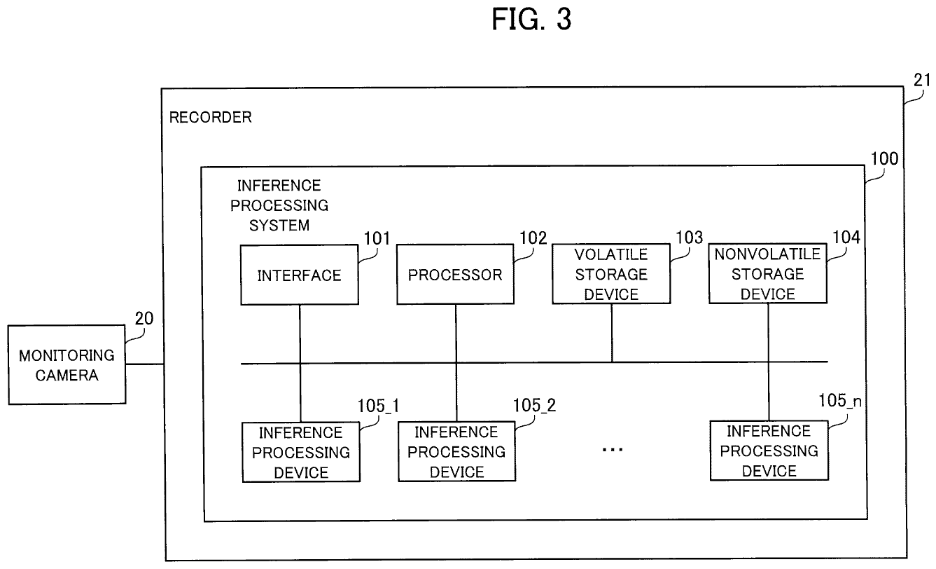

FIG. 3 is a diagram (No. 2) showing an example of actual use of the inference processing system in the first embodiment. FIG. 3 shows a case where a recorder 21 includes the inference processing system 100. Further, a monitoring camera 20 is connected to the recorder 21. A PC may be connected to the monitoring camera 20 instead of the recorder 21. The monitoring camera 20 transmits an image to the recorder 21. Then, for example, the inference processing system 100 in the recorder 21 makes the person inference by using the image (i.e., inference data) generated by the monitoring camera 20.

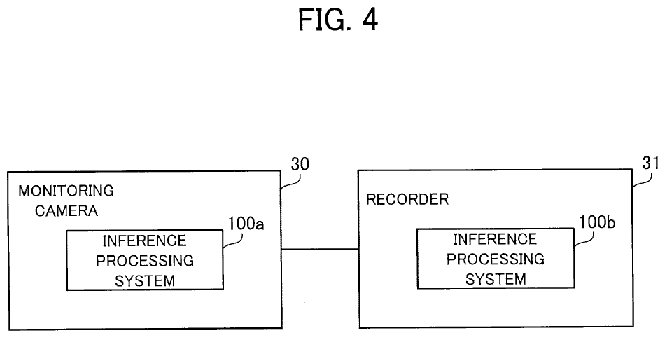

FIG. 4 is a diagram (No. 3) showing an example of actual use of the inference processing system in the first embodiment. FIG. 4 shows a monitoring camera 30 and a recorder 31. A PC may be connected to the monitoring camera 30 instead of the recorder 31.

The monitoring camera 30 includes an inference processing system 100a. The recorder 31 includes an inference processing system 100b. The inference processing system 100a and the inference processing system 100b achieve the same performance as the inference processing system 100.

For example, the inference processing device 105_1 is included in the inference processing system 100a. The inference processing devices 105_2, . . . , 105_n are included in the inference processing system 100b. As above, the inference processing devices may also be distributed.

A device including the inference processing system 100 is referred to as an information processing device. For example, the monitoring camera 10 or the recorder 31 is an information processing device.

In the following description, functions of the inference processing system 100 will be described by using the following information processing device.

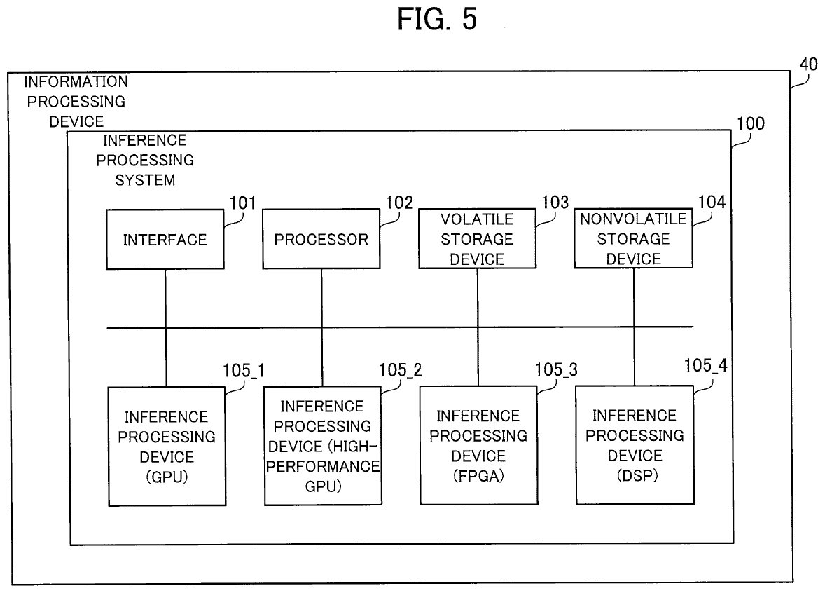

FIG. 5 is a diagram showing a case where the information processing device in the first embodiment includes the inference processing system. The information processing device 40 includes the inference processing system 100. The information processing device 40 is a device that executes a control method. The inference processing device 105_1 is implemented by a GPU. The inference processing device 105_2 is implemented by a high-performance GPU. The inference processing device 105_3 is implemented by an FPGA. The inference processing device 105_4 is implemented by a DSP.

Next, functions included in the information processing device 40 will be described below.

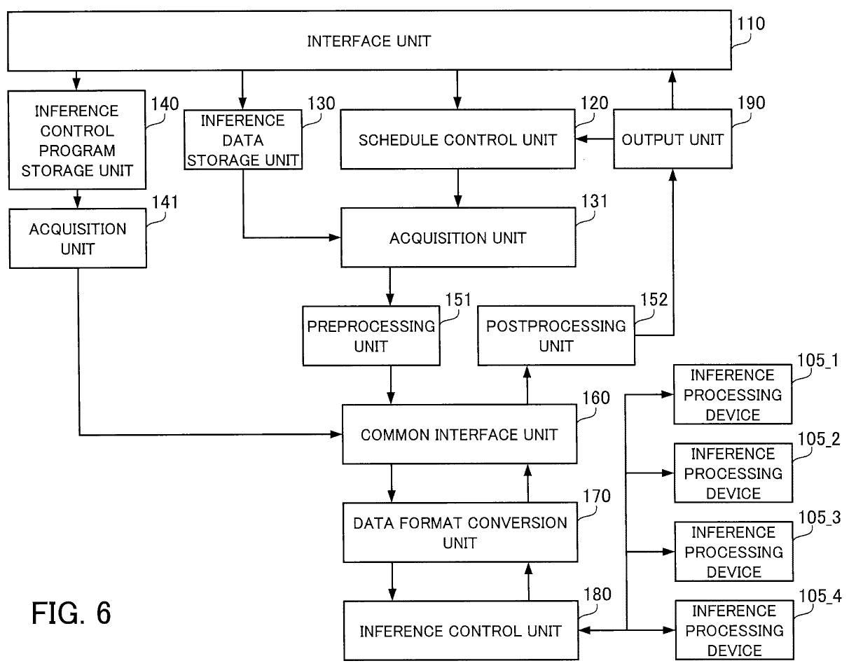

FIG. 6 is a block diagram showing the functions of the information processing device in the first embodiment. The information processing device 40 includes an interface unit 110, a schedule control unit 120, an inference data storage unit 130, an acquisition unit 131, an inference control program storage unit 140, an acquisition unit 141, a preprocessing unit 151, a postprocessing unit 152, a common interface unit 160, a data format conversion unit 170, an inference control unit 180 and an output unit 190.

The interface unit 110 may be implemented by the interface 101.

The inference data storage unit 130 and the inference control program storage unit 140 may be implemented as storage areas reserved in the volatile storage device 103 or the nonvolatile storage device 104.

Part or all of the schedule control unit 120, the acquisition unit 131, the acquisition unit 141, the preprocessing unit 151, the postprocessing unit 152, the common interface unit 160 and the output unit 190 may be implemented by processing circuitry. Further, part or all of the schedule control unit 120, the acquisition unit 131, the acquisition unit 141, the preprocessing unit 151, the postprocessing unit 152, the common interface unit 160 and the output unit 190 may be implemented as modules of a program executed by the processor 102.

The interface unit 110 transmits an inference scenario, information indicating the configuration of the inference processing devices, a learned model, and a memory use amount as the amount of memory used for each inference process to the schedule control unit 120. Incidentally, the inference scenario includes a list of inference processes, inference order, a function to be used in preprocessing or postprocessing, and an initial value of a parameter. Further, the learned model may be referred to also as an inference model. The information indicating the configuration of the inference processing devices includes the number of inference processing devices and the performance (e.g., memory capacity, the number of cores, the clock frequency, the number of threads, and bus speed) of each of the inference processing devices 105_1 to 105_4.

Further, the interface unit 110 transmits the inference data, as data to be used in an inference process, to the inference data storage unit 130. The inference data is an image, for example.

Furthermore, the interface unit 110 transmits an inference control program to the inference control program storage unit 140. Incidentally, the inference control program is a program for having the data format of the inference data converted to a data format appropriate for an inference processing device to be made to execute the inference process and making the inference processing device execute the inference process.

Next, the schedule control unit 120 will be described below.

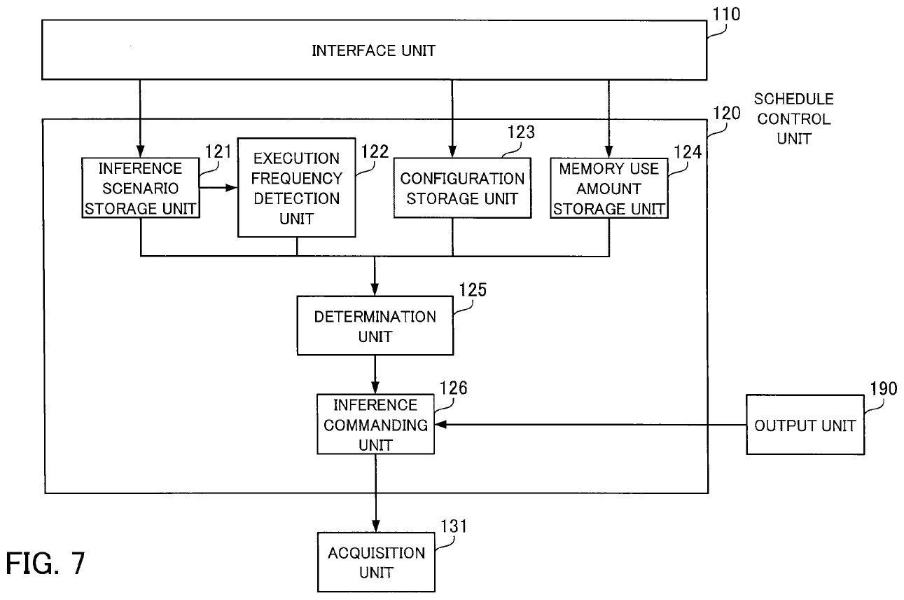

FIG. 7 is a block diagram showing functions of the schedule control unit in the first embodiment. The schedule control unit 120 includes an inference scenario storage unit 121, an execution frequency detection unit 122, a configuration storage unit 123, a memory use amount storage unit 124, a determination unit 125 and an inference commanding unit 126.

The inference scenario storage unit 121, the configuration storage unit 123 and the memory use amount storage unit 124 may be implemented as storage areas reserved in the volatile storage device 103 or the nonvolatile storage device 104.

Part or all of the execution frequency detection unit 122, the determination unit 125 and the inference commanding unit 126 may be implemented by processing circuitry. Further, part or all of the execution frequency detection unit 122, the determination unit 125 and the inference commanding unit 126 may be implemented as modules of a program executed by the processor 102.

The inference scenario storage unit 121 stores the inference scenario transmitted by the interface unit 110. The inference scenario storage unit 121 may store the learned model.

The execution frequency detection unit 122 detects an execution frequency of each inference process based on the inference scenario.

The configuration storage unit 123 stores the information indicating the configuration of the inference processing devices transmitted by the interface unit 110.

The memory use amount storage unit 124 stores the memory use amount as the amount of memory used for each inference process transmitted by the interface unit 110.

The determination unit 125 determines an inference processing device to be made to execute an inference process based on the information stored in the inference scenario storage unit 121, the configuration storage unit 123 and the memory use amount storage unit 124 and the execution frequency of each inference process. Further, the determination unit 125 may determine to make the processor 102 execute an inference process whose memory use amount is small and determine to make the inference processing devices 105_3 and 105_4 execute other inference processes. Furthermore, when the inference scenario indicates that three inference processes should be executed consecutively, the determination unit 125 may determine to make one inference processing device execute two inference processes whose execution frequency is low and determine to make another inference processing device execute the remaining one inference process. As above, the information processing device 40 may make a plurality of inference processing devices execute the inference processes by distributing the inference processes to the inference processing devices.

The inference commanding unit 126 transmits the inference scenario, an inference command and the learned model to the acquisition unit 131. Incidentally, the inference command includes device information indicating the inference processing device to be made to execute an inference process.

Next, returning to FIG. 6, the acquisition unit 131 will be described below.

The acquisition unit 131 acquires the inference scenario, the inference command and the learned model from the inference commanding unit 126. The acquisition unit 131 may also acquire the inference scenario, the inference command and the learned model from an external device via the interface unit 110. Incidentally, the external device is a device capable of connecting to the information processing device 40. Illustration of the external device is left out.

Further, the acquisition unit 131 acquires the inference data from the inference data storage unit 130. The acquisition unit 131 may also acquire the inference data from an external device via the interface unit 110.

The preprocessing unit 151 may perform preprocessing on the inference data. The preprocessing is, for example, normalization of the inference data, image processing, or the like. For example, the preprocessing unit 151 performs the preprocessing by using the function to be used in the preprocessing and the initial value of the parameter included in the inference scenario.

The acquisition unit 141 acquires the inference control program from the inference control program storage unit 140. For example, when the inference command includes the device information indicating the inference processing device 105_1 to be made to execute the inference process among the inference processing devices 105_1 to 105_4, the acquisition unit 141 has the data format of the inference data converted to a data format appropriate for the inference processing device 105_1 based on the device information and acquires the inference control program, for making the inference processing device 105_1 execute the inference process, from the inference control program storage unit 140. The acquisition unit 141 may also acquire the inference control program from an external device via the interface unit 110.

The common interface unit 160 transmits the inference data, the inference control program, the inference scenario, the learned model and the inference command to the data format conversion unit 170. When the preprocessing unit 151 has performed the preprocessing on the inference data, the common interface unit 160 transmits preprocessed inference data obtained by performing the preprocessing, the inference control program, the inference scenario, the learned model and the inference command to the data format conversion unit 170.

Here, the data format conversion unit 170 and the inference control unit 180 may be implemented by processing circuitry using the inference control program. Further, the data format conversion unit 170 and the inference control unit 180 may be implemented as modules of the inference control program executed by the processor 102.

When the preprocessing has been performed, the inference control program is a program for converting the data format of the preprocessed inference data to a data format appropriate for the inference processing device to be made to execute the inference process and for making the inference processing device execute the inference process.

The data format conversion unit 170 converts the data format of the inference data. The data format conversion unit 170 transmits converted inference data after the data format conversion, the inference scenario, the learned model and the inference command to the inference control unit 180. When the preprocessing has been performed, the data format conversion unit 170 converts the data format of the preprocessed inference data. The data format conversion unit 170 transmits converted preprocessed inference data after the data format conversion, the inference scenario, the learned model and the inference command to the inference control unit 180.

The inference control unit 180 makes the inference processing device execute the inference process by use of the converted inference data and the learned model. Specifically, when the device information indicates the inference processing device 105_1, the inference control unit 180 transmits the converted inference data and the learned model to the inference processing device 105_1. The inference control unit 180 transmits an inference execution command to the inference processing device 105_1. Accordingly, the inference processing device 105_1 executes the inference process by using the converted inference data and the learned model.

When the preprocessing has been performed, the inference control unit 180 makes the inference processing device execute the inference process by use of the converted preprocessed inference data and the learned model.

After the execution of the inference process, the inference control unit 180 acquires an inference result from the inference processing device that executed the inference process. The inference control unit 180 transmits the inference result to the data format conversion unit 170. As will be described later, when the inference result is not converted to common data, the inference control unit 180 transmits the inference result to the postprocessing unit 152.

The data format conversion unit 170 converts the inference result to the common data. The data format conversion unit 170 transmits the converted data to the postprocessing unit 152.

The postprocessing unit 152 performs the postprocessing on the received data (i.e., the inference result or the converted data). The postprocessing is, for example, feature analysis of the inference result, imaging of array data, or the like. For example, the postprocessing unit 152 performs the postprocessing by using the function to be used in the postprocessing and the initial value of the parameter included in the inference scenario. The postprocessing unit 152 transmits data obtained by the postprocessing to the output unit 190.

The output unit 190 outputs the received data to the interface unit 110. Further, the output unit 190 outputs an inference process completion notification to the inference commanding unit 126.

Here, the acquisition unit 131 and the acquisition unit 141 may also be implemented by one acquisition unit.

Further, the same number of units as the inference processing devices may exist in regard to each of the acquisition unit, the preprocessing unit, the postprocessing unit, the common interface unit, the data format conversion unit and the inference control unit.

Next, a process executed by the information processing device 40 will be described below by using a flowchart.

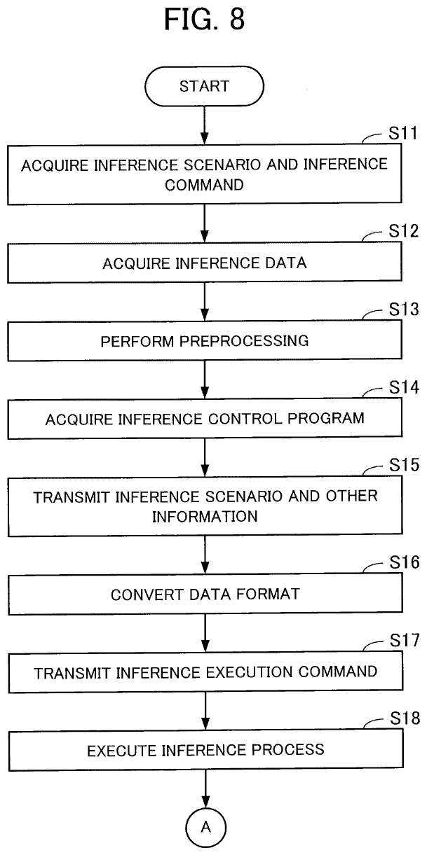

FIG. 8 is a flowchart (part 1) showing an example of the process executed by the information processing device in the first embodiment.
(Step S11) The acquisition unit 131 acquires the inference scenario, the learned model and the inference command from the schedule control unit 120.
(Step S12) The acquisition unit 131 acquires the inference data from the inference data storage unit 130.
(Step S13) The preprocessing unit 151 performs the preprocessing on the inference data.
(Step S14) The acquisition unit 141 acquires the inference control program from the inference control program storage unit 140.
(Step S15) The common interface unit 160 transmits the preprocessed inference data, the inference control program, the inference scenario, the learned model and the inference command to the data format conversion unit 170.
(Step S16) The data format conversion unit 170 converts the data format of the preprocessed inference data.
(Step S17) The inference control unit 180 makes the inference processing device execute the inference process by use of the converted preprocessed inference data and the learned model. For example, the inference control unit 180 transmits the inference execution command to the inference processing device.
(Step S18) The inference processing device executes the inference process.

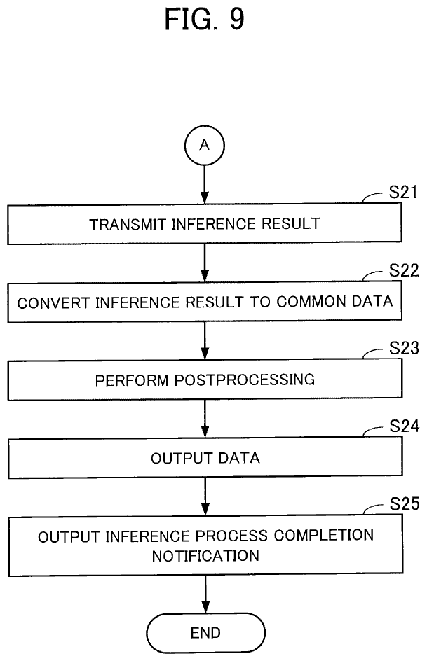

FIG. 9 is a flowchart (part 2) showing the example of the process executed by the information processing device in the first embodiment.
(Step S21) The inference control unit 180 transmits the inference result to the data format conversion unit 170.
(Step S22) The data format conversion unit 170 converts the inference result to the common data.
(Step S23) The postprocessing unit 152 performs the postprocessing on the received data.
(Step S24) The output unit 190 outputs the received data to the interface unit 110.
(Step S25) The output unit 190 outputs the inference process completion notification to the schedule control unit 120.

According to the first embodiment, the information processing device 40 includes the inference processing devices 105_1 to 105_4. The inference processing devices 105_1 to 105_4 differ from each other in the performance or the configuration. The information processing device 40 automatically converts the inference data to the data format appropriate for the inference processing device that executes the inference process. Therefore, the user does not need to execute the conversion work. Accordingly, the information processing device 40 is capable of reducing the load.

Further, the acquired inference control program is a program appropriate for the inference processing device. Therefore, the information processing device 40 is capable of executing control appropriate for the inference processing device by using the inference control program.

When the performance or the configuration of each of the inference processing devices 105_1 to 105_4 has been changed, the schedule control unit 120 automatically executes a process of replacing the inference control program depending on the inference processing device, by which the load on the user performing the work of setting an inference process to be executed by each of the inference processing devices 105_1 to 105_4 is reduced.

Further, when a new inference processing device has been added to the inference processing system 100, an inference processing program for the added inference processing device is generated and the inference processing program is inputted to the inference control program storage unit 140, and accordingly, the schedule control unit 120 determines the inference processing device to be made to execute an inference process. Then, the acquisition unit 141 acquires the inference control program from the inference control program storage unit 140. Accordingly, the load on the user performing the work of setting an inference process to be executed by each of the inference processing devices is reduced.

### Second Embodiment

Next, a second embodiment will be described below. In the second embodiment, the description will be given mainly of features different from those in the first embodiment. In the second embodiment, the description is omitted for features in common with the first embodiment.

As described earlier, the preprocessing unit 151 and the postprocessing unit 152 may be implemented by processing circuitry. Further, the preprocessing unit 151 and the postprocessing unit 152 may be implemented as modules of a program executed by the processor 102.

When the preprocessing unit 151 and the postprocessing unit 152 perform the processing at the same time, the load on the processing circuitry or the processor 102 becomes high. The situation where the load becomes high will be described specifically below.

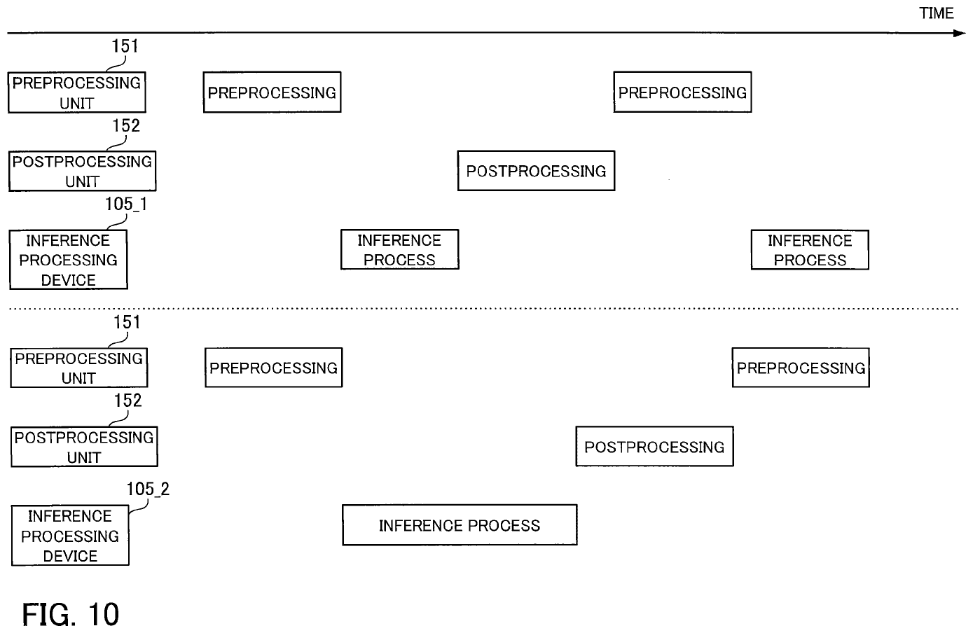

FIG. 10 is a diagram showing examples of the situation where the load becomes high in the second embodiment. The preprocessing unit 151 performs the preprocessing before the inference processing device 105_1 is made to execute an inference process. Further, the preprocessing unit 151 performs the preprocessing before the inference processing device 105_2 is made to execute an inference process. When the two preprocessings are performed at the same time as above, the load on the processing circuitry or the processor 102 becomes high.

Further, FIG. 10 shows a case where the postprocessing after the execution of an inference process by the inference processing device 105_1 and the postprocessing after the execution of an inference process by the inference processing device 105_2 are performed at the same time. When two postprocessings are performed at the same time as above, the load on the processing circuitry or the processor 102 becomes high.

Furthermore, FIG. 10 shows a case where the preprocessing before making the inference processing device 105_1 execute an inference process and the postprocessing after the execution of an inference process by the inference processing device 105_2 are performed at the same time. When preprocessing and postprocessing are performed at the same time as above, the load on the processing circuitry or the processor 102 becomes high.

Therefore, the information processing device 40 executes control so that the processing by the preprocessing unit 151 and the processing by the postprocessing unit 152 are not performed at the same time.

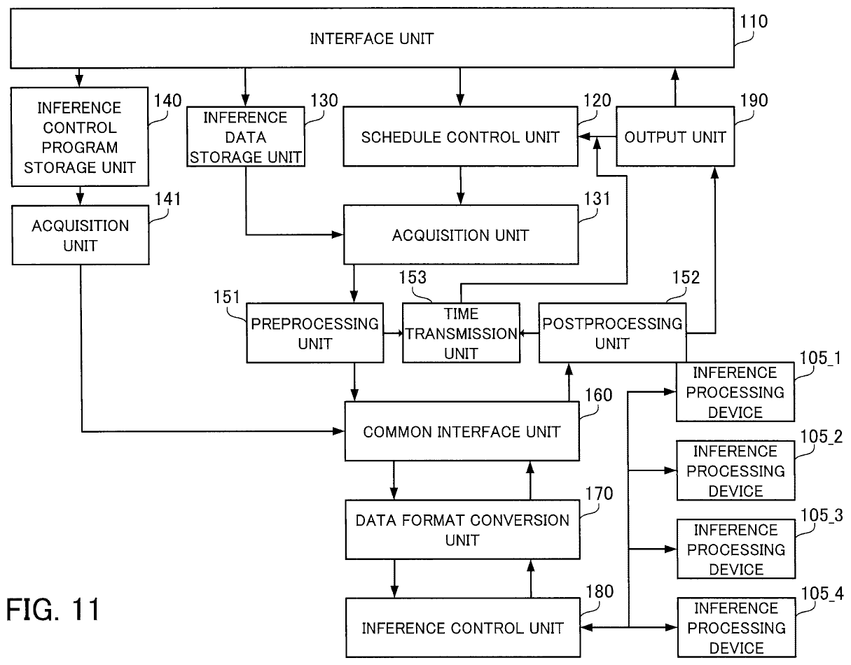

FIG. 11 is a block diagram showing functions of the information processing device in the second embodiment. The information processing device 40 further includes a time transmission unit 153. The time transmission unit 153 may be implemented by processing circuitry. Further, the time transmission unit 153 may be implemented as a module of a program executed by the processor 102.

The time transmission unit 153 receives a preprocessing time length from the preprocessing unit 151. The preprocessing time length is a time length for which the preprocessing is performed. Further, the time transmission unit 153 receives a postprocessing time length from the postprocessing unit 152. The postprocessing time length is a time length for which the postprocessing is performed. The time transmission unit 153 transmits the preprocessing time length and the postprocessing time length to the inference commanding unit 126.

Further, the inference control unit 180 acquires an inference process time length from an inference processing device. For example, the inference control unit 180 acquires the inference process time length from the inference processing device 105_1. The inference process time length is a time length for which the inference process is executed. The inference control unit 180 transmits the inference process time length to the time transmission unit 153 via the data format conversion unit 170, the common interface unit 160 and the postprocessing unit 152. The time transmission unit 153 transmits the inference process time length to the inference commanding unit 126.

The inference commanding unit 126 calculates a preprocessing time when the preprocessing should be performed, a postprocessing time when the postprocessing should be performed, and an inference process execution time when the inference process should be executed based on the preprocessing time length, the postprocessing time length and the inference process time length. As above, the inference commanding unit 126 calculates times at which a plurality of preprocessings are not performed at the same time. Further, the inference commanding unit 126 calculates times at which a plurality of postprocessings are not performed at the same time. Furthermore, the inference commanding unit 126 calculates times at which preprocessing and postprocessing are not performed at the same time. The inference commanding unit 126 transmits the inference scenario, the inference command, the preprocessing time, the postprocessing time, the learned model and the inference process execution time to the acquisition unit 131.

The acquisition unit 131 acquires the inference scenario, the inference command, the preprocessing time, the postprocessing time, the learned model and the inference process execution time from the inference commanding unit 126.

The preprocessing unit 151 performs the preprocessing at the preprocessing time. The inference control unit 180 makes the inference processing device execute the inference process at the inference process execution time. The postprocessing unit 152 performs the postprocessing at the postprocessing time.

Next, a process executed by the information processing device 40 will be described below by using a flowchart.

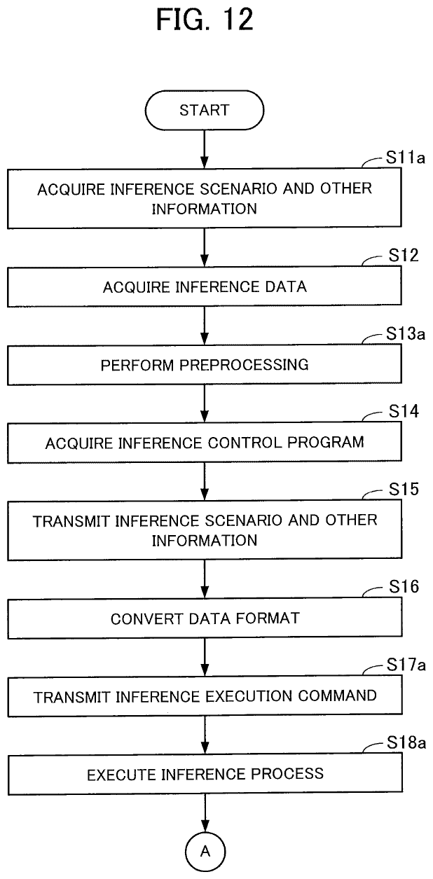

FIG. 12 is a flowchart (part 1) showing an example of the process executed by the information processing device in the second embodiment. The process in FIG. 12 differs from the process in FIG. 8 in that steps S11a, S13a, S17a and S18a are executed. Thus, the steps S11a, S13a, S17a and S18a in FIG. 12 will be described below. Then, the description will be omitted for processing other than the steps S11a, S13a, S17a and S18a.
(Step S11a) The acquisition unit 131 acquires the inference scenario, the inference command, the preprocessing time, the postprocessing time, the learned model and the inference process execution time from the schedule control unit 120.
(Step S13a) The preprocessing unit 151 performs the preprocessing on the inference data at the preprocessing time.
(Step S17a) The inference control unit 180 makes the inference processing device execute the inference process by use of the converted preprocessed inference data and the learned model at the inference process execution time. For example, the inference control unit 180 transmits the inference execution command to the inference processing device.
(Step S18a) The inference processing device executes the inference process at the inference process execution time.

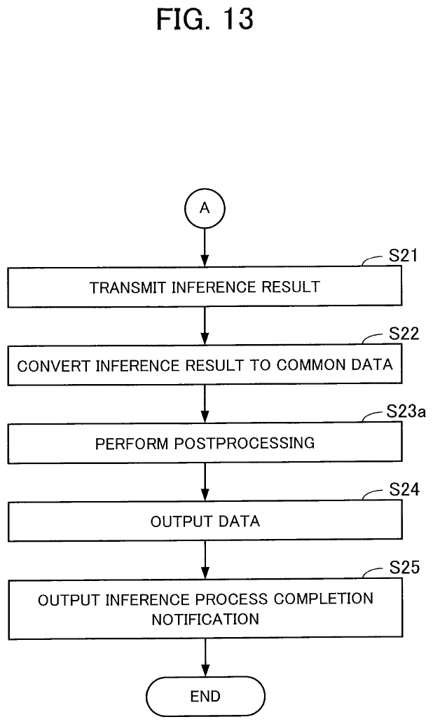

FIG. 13 is a flowchart (part 2) showing the example of the process executed by the information processing device in the second embodiment. The process in FIG. 13 differs from the process in FIG. 9 in that step S23a is executed. Thus, the step S23a in FIG. 13 will be described below. Then, the description will be omitted for processing other than the step S23a.
(Step S23a) The postprocessing unit 152 performs the postprocessing on the received data at the postprocessing time.

An example of a case where the information processing device 40 has executed control so that the processing by the preprocessing unit 151 and the processing by the postprocessing unit 152 are not executed at the same time will be shown below.

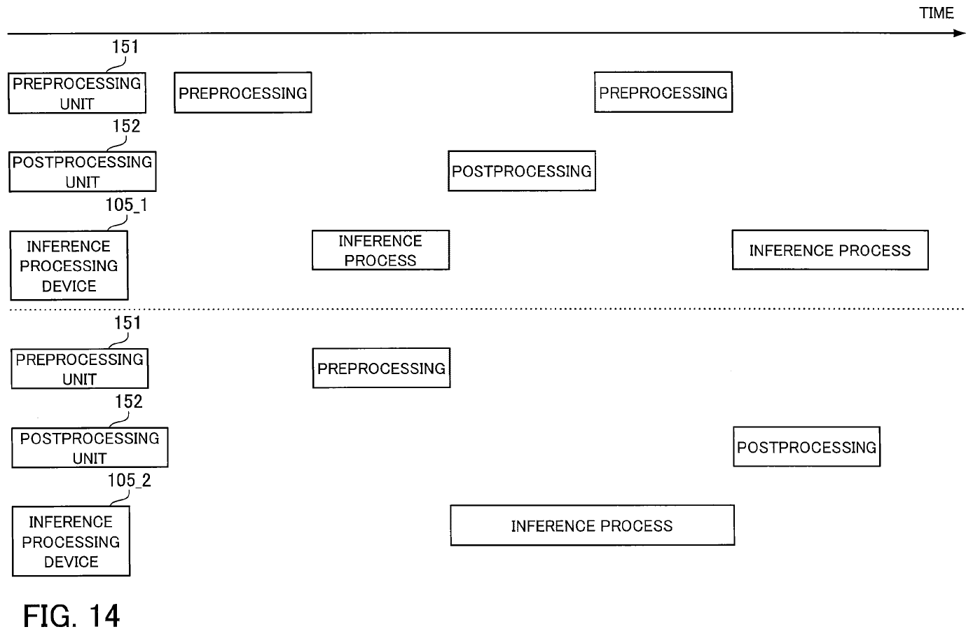

FIG. 14 is a diagram showing an example of a situation where the control in the second embodiment has been executed. As shown in FIG. 14, the processing by the preprocessing unit 151 and the processing by the postprocessing unit 152 are not executed at the same time. Accordingly, the load on the processing circuitry or the processor 102 is reduced.

According to the second embodiment, the information processing device 40 is capable of reducing the load on the processing circuitry or the processor 102.

Further, the preprocessing time length, the postprocessing time length and the inference process time length may be transmitted also to the determination unit 125. When determining the inference processing device to be made to execute an inference process, the determination unit 125 may determine the inference processing device by using the preprocessing time length, the postprocessing time length and the inference process time length.

As shown in FIG. 4, the inference processing devices may be distributed. For example, the monitoring camera 30 is referred to also as a first device. Further, for example, the recorder 31 is referred to also as a second device. Furthermore, a system including the monitoring camera 30 and the recorder 31 may be referred to also as an inference system. The monitoring camera 30 includes one or more inference processing devices. The recorder 31 includes one or more inference processing devices. The monitoring camera 30 or the recorder 31 includes the functions shown in FIG. 6. For example, the monitoring camera 30 or the recorder 31 includes the acquisition unit that acquires the learned model, the inference data, and the inference control program for having the inference data converted to a data format appropriate for a first inference processing device to be made to execute an inference process out of the one or more inference processing devices included in the monitoring camera 30 and the one or more inference processing devices included in the recorder 31 and making the first inference processing device execute the inference process, the data format conversion unit that converts the data format of the inference data, and the inference control unit that makes process by use of the converted inference data and the learned model.

Features in the embodiments described above can be appropriately combined with each other.

### DESCRIPTION OF REFERENCE CHARACTERS

10: monitoring camera, 11: recorder, 20: monitoring camera, 21: recorder, 30: monitoring camera, 31: recorder, 40: information processing device, 100: inference processing system, 100a: inference processing system, 100b: inference processing system, 101: interface, 102: processor, 103: volatile storage device, 104: nonvolatile storage device, 105_1, 105_2, 105_3, 105_4, . . . , 105_n: inference processing device, 110: interface unit, 120: schedule control unit, 121: inference scenario storage unit, 122: execution frequency detection unit, 123: configuration storage unit, 124: memory use amount storage unit, 125: determination unit, 126: inference commanding unit, 130: inference data storage unit, 131: acquisition unit, 140: inference control program storage unit, 141: acquisition unit, 151: preprocessing unit, 152: postprocessing unit, 153: time transmission unit, 160: common interface unit, 170: data format conversion unit, 180: inference control unit, 190: output unit

1. An information processing device comprising:
a plurality of inference processing devices differing from each other in performance or a configuration;
acquiring circuitry to acquire a learned model, inference data as data to be used in an inference process, and an inference control program for having a data format of the inference data converted to a data format appropriate for a first inference processing device to be made to execute the inference process out of the plurality of inference processing devices and making the first inference processing device execute the inference process;
data format converting circuitry to convert the data format of the inference data; and
inference controlling circuitry to make the first inference processing device execute the inference process by use of converted inference data after the data format conversion and the learned model.

2. The information processing device according to claim 1, further comprising preprocessing circuitry to perform preprocessing on the inference data, wherein
the inference control program is a program for converting the data format of preprocessed inference data obtained by performing the preprocessing to a data format appropriate for the first inference processing device,
the data format converting circuitry converts the data format of the preprocessed inference data, and
the inference controlling circuitry makes the first inference processing device execute the inference process by use of converted preprocessed inference data after the data format conversion and the learned model.

3. The information processing device according to claim 2, further comprising:
postprocessing circuitry to perform postprocessing on an inference result or data obtained by converting the inference result; and
schedule controlling circuitry to calculate a preprocessing time when the preprocessing should be performed, a postprocessing time when the postprocessing should be performed, and an inference process execution time when the inference process should be executed so that a plurality of the preprocessings are not performed at the same time, a plurality of the postprocessings are not performed at the same time, or the preprocessing and the postprocessing are not performed at the same time based on a preprocessing time length as a time length for which the preprocessing is performed, a postprocessing time length as a time length for which the postprocessing is performed, and an inference process time length as a time length for which the inference process is executed, wherein
the preprocessing circuitry performs the preprocessing at the preprocessing time,
the inference controlling circuitry makes the first inference processing device execute the inference process at the inference process execution time, and
the postprocessing circuitry performs the postprocessing at the postprocessing time.

4. An inference system comprising:
a first device including one or more inference processing devices; and
a second device including one or more inference processing devices, wherein
the one or more inference processing devices included in the first device and the one or more inference processing devices included in the second device differ from each other in performance or a configuration, and
the first device or the second device includes:
acquiring circuitry to acquire a learned model, inference data as data to be used in an inference process, and an inference control program for having a data format of the inference data converted to a data format appropriate for a first inference processing device to be made to execute the inference process out of the one or more inference processing devices included in the first device and the one or more inference processing devices included in the second device and making the first inference processing device execute the inference process;
data format converting circuitry to convert the data format of the inference data; and
inference controlling circuitry to make the first inference processing device execute the inference process by use of converted inference data after the data format conversion and the learned model.

5. A control method performed by an information processing device including a plurality of inference processing devices differing from each other in performance or a configuration, the control method comprising:
acquiring a learned model, inference data as data to be used in an inference process, and an inference control program for having a data format of the inference data converted to a data format appropriate for a first inference processing device to be made to execute the inference process out of the plurality of inference processing devices and making the first inference processing device execute the inference process;
converting the data format of the inference data; and
making the first inference processing device execute the inference process by use of converted inference data after the data format conversion and the learned model.
